(19) United States
(12) Patent Application Publication
(10) Pub. No.: US 2008/0120115 A1
(43) Pub. Date: May 22, 2008

(54) Methods and apparatuses for dynamically adjusting an audio signal based on a parameter

(76) Inventor: Xiao Dong Mao, Foster City, CA (US)

Correspondence Address: Valley Oak Law, 5655 Silver Creek Valley Road, #106, San Jose, CA, 95138, US

(21) Appl. No.: 11/600,938

(22) Filed: Nov. 16, 2006

(51) Int. Cl. G10L 21/00

(52) U.S. Cl. 704/278; 704/E11.002

(57) ABSTRACT

In one embodiment, the methods and apparatuses detect an original audio signal;detect a sound model wherein the sound model includes a sound parameter; transform the original audio signal based on the parameter whereby forming a transformed audio signal; and compare the transformed audio signal with the original audio signal.

### FIELD OF THE INVENTION

The present invention relates generally to adjusting an audio signal and, more particularly, to dynamically adjusting an audio signal based on a parameter.

### BACKGROUND

There are many devices that amplify and modify an audio signal. For example, megaphones are typically capable of amplifying an audio input such as a voice. Further, some megaphones are also capable of adjusting the pitch of the audio input such that the output audio signal has a pitch that is either increased or decreased relative to the audio input.

### SUMMARY

In one embodiment, the methods and apparatuses detect an original audio signal;detect a sound model wherein the sound model includes a sound parameter; transform the original audio signal based on the parameter whereby forming a transformed audio signal; and compare the transformed audio signal with the original audio signal.

### BRIEF DESCRIPTION OF THE DRAWINGS

The accompanying drawings, which are incorporated in and constitute a part of this specification, illustrate and explain one embodiment of the methods and apparatuses for dynamically adjusting an audio signal based on a parameter. In the drawings, FIG. 1 is a diagram illustrating an environment within which the methods and apparatuses for dynamically adjusting an audio signal based on a parameter are implemented;

FIG. 2 is a simplified block diagram illustrating one embodiment in which the methods and apparatuses for dynamically adjusting an audio signal based on a parameter are implemented;

FIG. 3 is a schematic diagram illustrating a microphone device and driver in which the methods and apparatuses for dynamically adjusting an audio signal based on a parameter are implemented;

FIG. 4 is a schematic diagram illustrating basic modules in which the methods and apparatuses for dynamically adjusting an audio signal based on a parameter are implemented;

FIG. 5 illustrates an exemplary record consistent with one embodiment of the methods and apparatuses for dynamically adjusting an audio signal based on a parameter;

FIG. 6 is a flow diagram consistent with one embodiment of the methods and apparatuses for dynamically adjusting an audio signal based on a parameter;

FIG. 7 is a flow diagram consistent with one embodiment of the methods and apparatuses for dynamically adjusting an audio signal based on a parameter; and

FIG. 8 is a flow diagram consistent with one embodiment of the methods and apparatuses for dynamically adjusting an audio signal based on a parameter.

### DETAILED DESCRIPTION

The following detailed description of the methods and apparatuses for dynamically adjusting an audio signal based on a parameter refers to the accompanying drawings. The detailed description is not intended to limit the methods and apparatuses for dynamically adjusting an audio signal based on a parameter. Instead, the scope of the methods and apparatuses for automatically selecting a profile is defined by the appended claims and equivalents. Those skilled in the art will recognize that many other implementations are possible, consistent with the methods and apparatuses for dynamically adjusting an audio signal based on a parameter.

References to “electronic device” include a device such as a personal digital video recorder, digital audio player, gaming console, a set top box, a computer, a cellular telephone, a personal digital assistant, a specialized computer such as an electronic interface with an automobile, and the like.

References to “audio signal” and “audio signals” include but are not limited to representations of voice sounds and audio sounds in both analog and digital forms. In one embodiment, audio signal(s) may include voice convert signals that represent vectorized voice signals which aid in efficient real-time voice conversion.

In one embodiment, the methods and apparatuses for dynamically adjusting an audio signal based on a parameter are configured to transform incoming audio signals into modified audio signals based on at least one parameter. In one embodiment, the incoming audio signals represent a user's voice. Further, the modified audio signals are changed according to at least one parameter. In one embodiment, the parameter is associated with a characteristic of sound. In another embodiment, the parameter is configured to correspond to a target sound such as a celebrity's voice. For example, the parameter may change the pitch of the incoming audio signal to more closely match the rhythm of Arnold Schwarzenegger's voice.

FIG. 1 is a diagram illustrating an environment within which the methods and apparatuses for dynamically adjusting an audio signal based on a parameter are implemented. The environment includes an electronic device 110 (e.g., a computing platform configured to act as a client device, such as a personal digital video recorder, digital audio player, computer, a personal digital assistant, a cellular telephone, a camera device, a set top box, a gaming console), a user interface 115, a network 120 (e.g., a local area network, a home network, the Internet), and a server 130 (e.g., a computing platform configured to act as a server). In one embodiment, the network 120 can be implemented via wireless or wired solutions.

In one embodiment, one or more user interface 115 components are made integral with the electronic device 110 (e.g., keypad and video display screen input and output interfaces in the same housing as personal digital assistant electronics (e.g., as in a Clie®) manufactured by Sony Corporation). In other embodiments, one or more user interface 115 components (e.g., a keyboard, a pointing device such as a mouse and trackball, a microphone, a speaker, a display, a camera) are physically separate from, and are conventionally coupled to, electronic device 110. The user utilizes interface 115 to access and control content and applications stored in electronic device 110, server 130, or a remote storage device (not shown) coupled via network 120.

In accordance with the invention, embodiments of dynamically adjusting an audio signal based on a parameter as described below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

The methods and apparatuses for dynamically adjusting an audio signal based on a parameter are shown in the context of exemplary embodiments of applications in which the user profile is selected from a plurality of user profiles. In one embodiment, the user profile is accessed from an electronic device 110 and content associated with the user profile can be created, modified, and distributed to other electronic devices 110.

In one embodiment, access to create or modify content associated with the particular user profile is restricted to authorized users. In one embodiment, authorized users are based on a peripheral device such as a portable memory device, a dongle, and the like. In one embodiment, each peripheral device is associated with a unique user identifier which, in turn, is associated with a user profile.

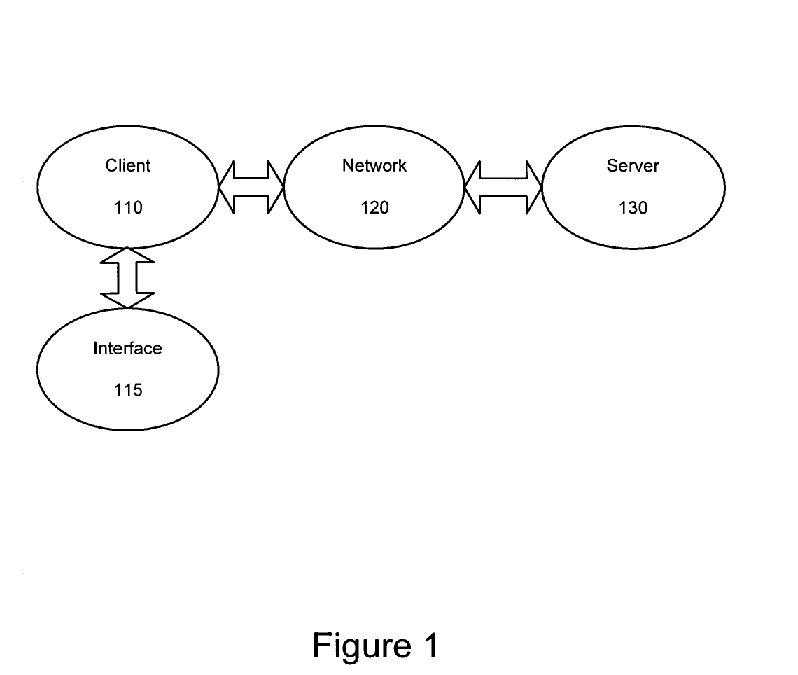

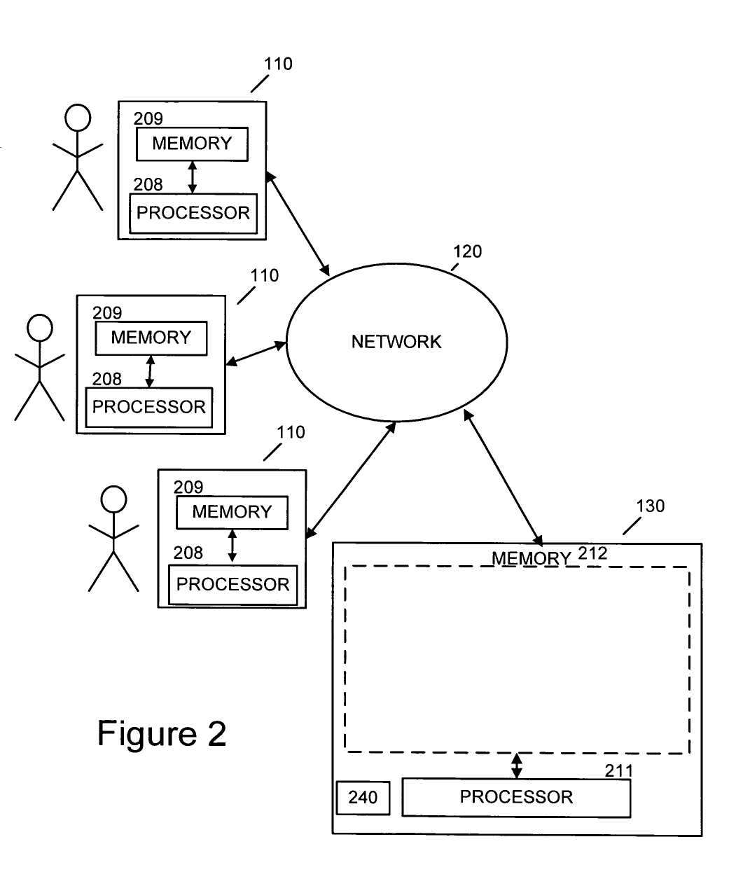

FIG. 2 is a simplified diagram illustrating an exemplary architecture in which the methods and apparatuses for dynamically adjusting an audio signal based on a parameter are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. A unique user operates each electronic device 110 via an interface 115 as described with reference to FIG. 1.

Server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

The plurality of client devices 110 and the server 130 include instructions for a customized application for dynamically adjusting an audio signal based on a parameter. In one embodiment, the plurality of computer-readable medium 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in memories 209, in memory 211, or a single user application is stored in part in one memory 209 and in part in memory 211. In one instance, a stored user application, regardless of storage location, is made customizable based on capturing an audio signal based on a location of the signal as determined using embodiments described below.

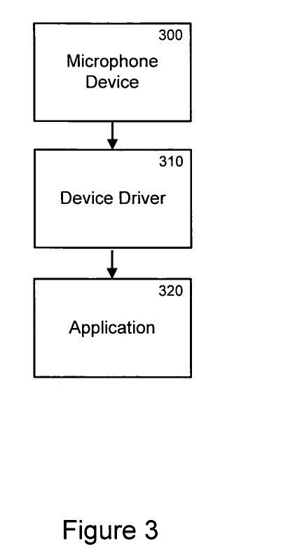

FIG. 3 illustrates one embodiment of a microphone device 300, a device driver 310, and an application 320 operating in conjunction with the methods and apparatuses for dynamically adjusting an audio signal based on a parameter. In one embodiment, the device driver 310 is packaged with the microphone device 300. Further, the device driver 310 and the microphone device 300 are capable of being selectively coupled to the application 320. In one embodiment, the application 320 resides within a client device 110.

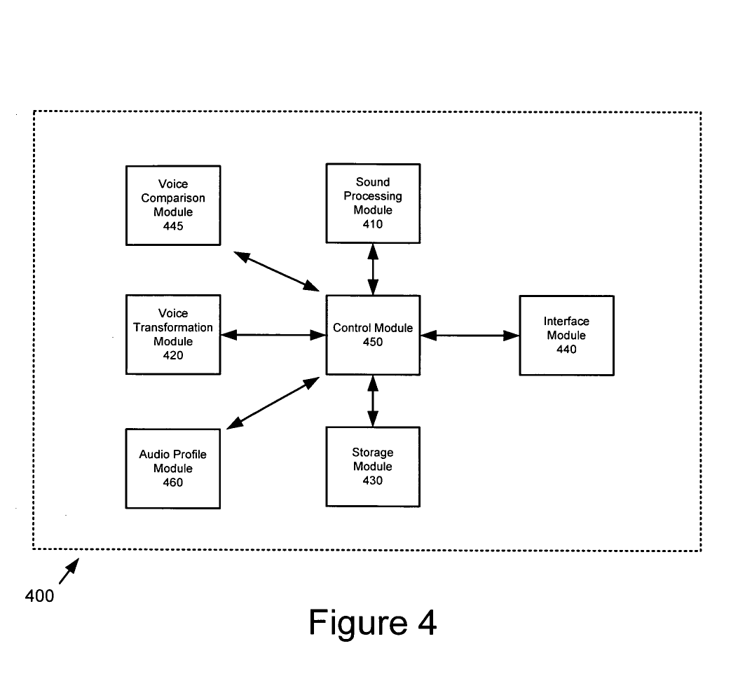

FIG. 4 illustrates one embodiment of a system 400 for dynamically adjusting an audio signal based on a parameter. The system 400 includes a sound processing module 410, a voice transformation module 420, a storage module 430, an interface module 440, a voice comparison module 445, a control module 450, and a sound profile module 460. In one embodiment, the control module 450 communicates with the sound processing module 410, the voice transformation module 420, the storage module 430, the interface module 440, the voice comparison module 445, and the sound profile module 460.

In one embodiment, the control module 450 coordinates tasks, requests, and communications between the sound processing module 410, the voice transformation module 420, the storage module 430, the interface module 440, the voice comparison module 445, and the sound profile module 460.

In one embodiment, the sound processing module 410 is configured to process incoming audio signals received by the system 400. In one embodiment, the sound processing module 410 formats the incoming audio signals to be usable to the voice conversion module 420.

In one embodiment, the sound processing module 410 converts the incoming audio signals through a voice feature extraction procedure. In one embodiment, the voice feature extraction procedure utilized two types of features: a short-term MFCC feature vector, and a long-term rhythm feature.

For example, various portions of the voice feature extraction procedure are shown as exemplary embodiments. In one instance, a target voice from the the recorded audio input stream is detected. Further, a microphone array can be used to enhance the detection accuracy that captures the target voice that is presented within the target listening direction or target listening area.

In another instance, a one dimensional audio signal for the detected voice is then accumulated and collected into a frame buffer. For example, a frame length of 128 audio samples (8 msec at 16 kHz) can be used for low latency real-time voice converter use. However, other frame lengths may be utilized without departing from the invention. Further, this signal frame is then transformed to frequency domain (called Short-Term Fourier Analysis), and the phase information is saved for later Fourier Synthesis to re-generate the time domain audio signal.

In yet another instance, the frequency domain spectrum amplitudes of the frequency bins are grouped into 13 bands and generates 13-dimention Mel-Function cepstrum coefficients (MFCC) in one embodiment. In one embodiment, the energy of MFCC vector is saved for later Fourier Synthesis to re-generate the time domain audio signal with correct signal amplitude information.

In one embodiment, a long-term rhythm feature can be generated from the statistical average of short-term MFCC feature. For example, by taking the second-order statistics (covariance) of the former generated short-term MFCC vectors, this covariance matrix (triangular positive matrix) is then further normalized by following steps: utilizing a vocal track normalization (a standard procedure in speech recognizer); transforming this matrix with Principle-Component-Analysis (PCA), whereby this PCA matrix is trained by the target voices (for example, pre-recorded president Bush's voices), and this process can further compress the covariance matrix energy towards diagonal; further compressing the covariance into approximately diagonal via Maximum-Likelihood-Linear-Transform (MLLT); and forming the final long-term rhythm feature vector through the diagonal elements of the covariance matrix.

In one embodiment, the short-term MFCC feature vector (13-dimension) is merged with the long-term rhythm feature vector (13-dimension) and a resultant new “voice feature vector” with 26-dimension is formed. In one embodiment, this “voice feature vector” is utilized as the training/recognition input vector.

In one embodiment, the voice transformation module 420 is configured to transform the incoming audio signals based on the particular sound parameters that are specified. Further, the voice transformation module 420 transforms the incoming audio signals into transformed audio signals. In one embodiment, the specific sound parameters depend on the type of sound effects that are desired in the resultant, transformed sound signals.

In one embodiment, the voice transformation module 420 utilizes a sound model that contains specific parameters to modify the incoming audio signals. The sound model is discussed in greater detail below.

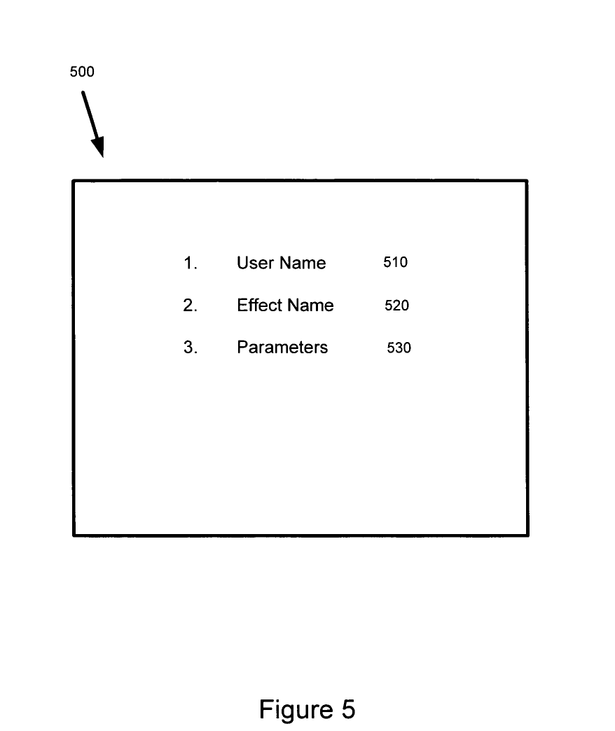

In one embodiment, the storage module 430 stores a plurality of profiles wherein each profile is associated with a different set of sound parameters. For example, each set of sound parameters may correspond to a different celebrity voice, a different sound effect, and the like. In one embodiment, the profile stores various information as shown in an exemplary profile in FIG. 5. In one embodiment, the storage module 430 is located within the server device 130. In another embodiment, portions of the storage module 430 are located within the electronic device 110. In another embodiment, the storage module 430 also stores a representation of the audio signals detected.

In one embodiment, the interface module 440 detects audio signals other devices such as the electronic device 110. Further, the interface module 440 transmits the resultant, transformed audio signals from the system 400 to other electronic devices 110 in the form of a digital representation of the transformed audio signals in one embodiment. In another embodiment, the interface module 440 transmits the resultant, transformed audio signals from the system 400 in the form of an analog representation of the transformed signal through a speaker.

In one embodiment, the voice comparison module 445 is configured to compare the transformed audio signals with bench mark audio signals. In one embodiment, the benchmark audio signals are the incoming audio signal with the set of sound parameters applied to the incoming audio signal. In this embodiment, the voice comparison module 445 monitors the error between the transformed audio signals and the incoming audio signals with the sound parameters applied to the incoming signals.

In another embodiment, the benchmark audio signals are audio signals that represent a source associated with the sound model utilized to create the set of sound parameters. For example, the benchmark audio signals may include the actual celebrity voice that is utilized to create the sound parameters. In another example, the benchmark audio signals comprise recorded media such as movies and albums that were previously recorded by the artist associate with the sound model.

In one embodiment, the audio profile module 460 processes profile information related to specific audio characteristics for the particular audio profile. For example, the profile information may include voice parameters such as speed of speech, pitch, inflection points, rhythm, formant characteristics, and the like.

In one embodiment, the audio profile module 460 determines an appropriate sound model. In one embodiment, a sound model corresponds with a particular source sound and is utilized to modify the incoming audio signal such that the modified audio signal more closely resembles the particular source sound. For example, there is a sound model associated with the actor Arnold Schwarzenegger. The sound model associated with Arnold Schwarzenegger is configured to modify the incoming audio signal such that the modified audio signal more closely resembles the voice of Arnold Schwarzenegger (source sound).

The sound model may be expressed in term of an equation:

ƒ(x,y)=ƒ(y)*ƒ(x/y)=ƒ(x)*ƒ(y/x) (equation 1)

### The function ƒ(y) represents the incoming audio signal, and the function ƒ(x) represents the source sound.

η(x/y)=ƒ(x)*ƒ(y/x)/ƒ(y) (equation 2)

Typically, the incoming audio signal (ƒ(y)) and the source sound (ƒ(x)) are independent of each other. Because of this independence between the incoming audio signal and the source sound, Bayes's Theorem can be applied. The modified audio signal is represented by function ƒ(x/y), and the sound model is represented by the function ƒ(y/x).

In one embodiment, exemplary profile information is shown within a record illustrated in FIG. 5. In one embodiment, the audio profile module 460 utilizes the profile information. In another embodiment, the audio profile module 460 creates additional records having additional profile information.

The system 400 in FIG. 4 is shown for exemplary purposes and is merely one embodiment of the methods and apparatuses for dynamically adjusting an audio signal based on a parameter. Additional modules may be added to the system 400 without departing from the scope of the methods and apparatuses for dynamically adjusting an audio signal based on a parameter. Similarly, modules may be combined or deleted without departing from the scope of the methods and apparatuses for dynamically adjusting an audio signal based on a parameter.

FIG. 5 illustrates a simplified record 500 that corresponds to a profile that describes a particular voice profile. In one embodiment, the record 500 is stored within the storage module 430 and utilized within the system 400. In one embodiment, the record 500 includes a user name field 510, an effect name field 520, and a parameters field 530.

In one embodiment, the user name field 510 provides a customizable label for a particular user. For example, the user identification field 510 may be labeled with arbitrary names such as “Bob”, “Emily's Profile”, and the like.

In one embodiment, the effect name field 520 uniquely identifies each profile for altering audio signals. For example, in one embodiment, the effect name field 520 describes the type of effect on the audio signals. For example, the effect name field 520 may be labeled with a descriptive name such as “Man's Voice”, “Radio Announcer”, and the like. Further, the effect name field 520 may be further labeled for a celebrity such as “Arnold Schwarzenegger”, “Michael Jackson”, and the like.

In one embodiment, the parameter field 530 describes the parameters that are utilized in altering the incoming audio signals and producing transformed audios signals. In one embodiment, the parameters utilized modify the pitch, cadence, speed, inflection, formant, and rhythm of the incoming audio signals. In one embodiment, the incoming audio signals represent an initial voice and the transformed audio signals represent an altered voice. In one embodiment, the altered voice represents a voice belonging to a celebrity.

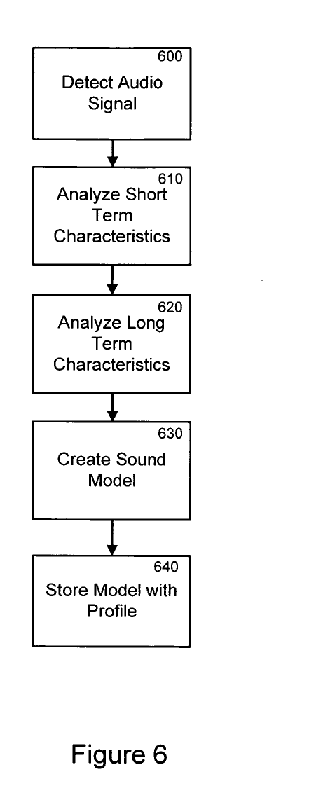

The flow diagrams as depicted in FIGS. 6, 7, and 8 are one embodiment of the methods and apparatuses for dynamically adjusting an audio signal based on a parameter. The blocks within the flow diagrams can be performed in a different sequence without departing from the spirit of the methods and apparatuses for dynamically adjusting an audio signal based on a parameter. Further, blocks can be deleted, added, or combined without departing from the spirit of the methods and apparatuses for dynamically adjusting an audio signal based on a parameter.

The flow diagram in FIG. 6 illustrates creating a voice profile according to one embodiment of the invention.

In Block 600, an audio signal is detected. In one embodiment, the audio signal is a representation of a voice. In another embodiment, the audio signal is a representation of a sound. The length of the audio signal is detected over a period of time. In one embodiment, the period of time is over the course of several seconds. In another embodiment, the period of time is over the course of several minutes. In one embodiment, the audio signal is divided into separate frames. In one instance, each frame contains between 8 and 20 milliseconds of the audio signal. In one embodiment, a series of frames comprise a contiguous portion of the audio signal.

In Block 610, the audio signal is analyzed according to short term characteristics. In one embodiment, the audio signal is analyzed by each frame for short term characteristics such as pitch and formant. Techniques such as Mel Frequency Cepstral Coefficients (MFCC) and Mel Perceptual Linear Prediction (MPLP) are utilized to analyze each frame for short term characteristics. By analyzing the short term characteristics through MFCC and MPLP, the amplitude spectrum of the sound for each frame is obtained.

In Block 620, the audio signal is analyzed according to long term characteristics. In one embodiment, the audio signal is analyzed over a period of one to five seconds. For example, multiple frames are analyzed to obtain long term characteristics such as rhythm, spectral envelope, and short term artifacts.

In Block 630, the sound model is created based on the short term and long term characteristics of the audio signal. In one embodiment, a Gaussian mixture model (GMM) is utilized to create a model that approximates the sound model. For example, the sound model may be utilized to transform an audio signal into the detected audio signal within the Block 600.

In Block 640, the sound model is stored within a profile. In one embodiment, the sound model is stored with the exemplary record 500. In one instance, the sound model is associated with a particular voice or sound. When utilized, the sound model is configured to transform an audio signal into the particular voice or sound. For example, if the voice associated with the sound model represents Arnold Schwarzenegger, then this particular sound model can be applied to another voice with the resultant, transformed sound having characteristics of Arnold Schwarzenegger's voice.

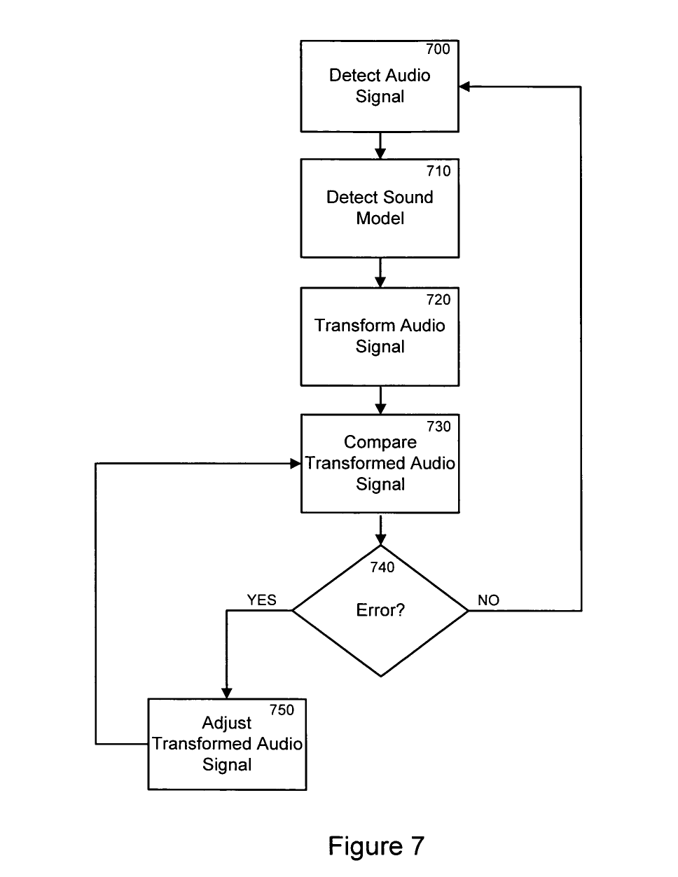

The flow diagram in FIG. 7 illustrates dynamically transforming an audio signal based on a parameter according to one embodiment of the invention.

In Block 700, an audio signal is detected. In one embodiment, the audio signal is a representation of a voice. In another embodiment, the audio signal is a representation of a sound. The length of the audio signal is detected over a period of time. In one embodiment, the period of time is over the course of several seconds. In another embodiment, the period of time is over the course of several minutes. In one embodiment, the audio signal is divided into separate frames. In one instance, each frame contains between 8 and 20 milliseconds of the audio signal. In one embodiment, a series of frames comprise a contiguous portion of the audio signal.

In Block 710, a sound model is detected. In one embodiment, the sound model is stored within a profile as shown in the Block 640. Further, the sound model is shown as being created within the Block 630 in one embodiment.

In Block 720, the audio signal as detected in the Block 700 is transformed according to at least one parameter as described within the sound model as detected in the Block 710.

In Block 730, the transformed audio signal is compared against the audio signal detected in the Block 700 and the sound model detected in the Block 710 for errors.

In Block 740, if there is an error, then the transformed audio signal from the Block 720 is adjusted in Block 750 based on the error detected within the Block 740 and the comparison in the Block 730. After the transformed audio signal is adjusted in the Block 750, then the newly adjusted transformed audio signal is compared to the detected audio signal in the Block 700 and the sound model detected in the Block 710.

If there is no error in the Block 740, then an additional audio signal is detected in the Block 700.

In use, the audio signal detected in the Block 700 represents a voice that originates from a user. Further, the sound model detected in the Block 710 is a celebrity voice such as Michael Jackson. In this instance, the userwished to have the user's voice changed into Michael Jackson's voice.

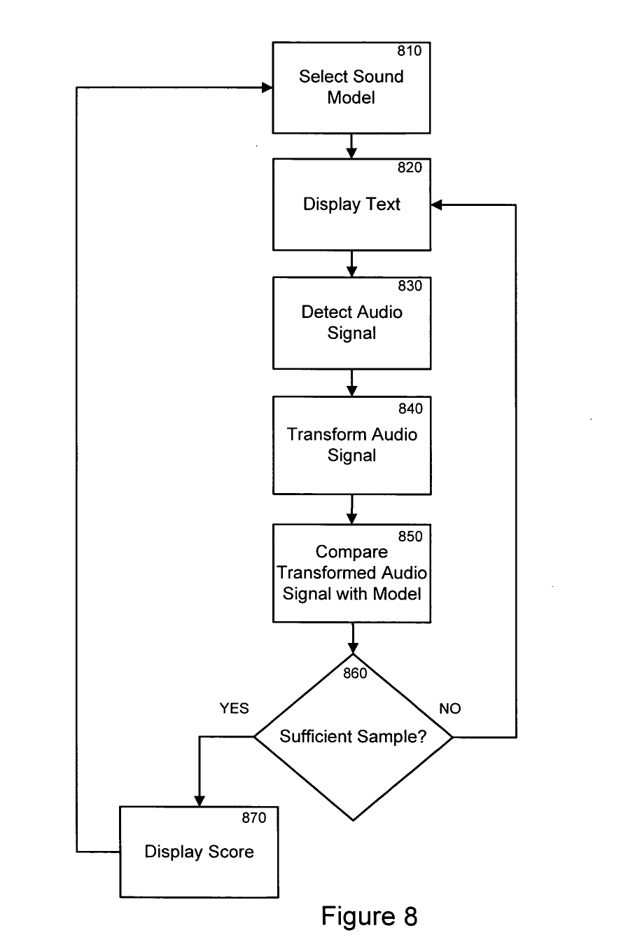

The flow diagram in FIG. 8 illustrates displaying a score reflecting a match between the transformed audio signal and the sound model according to one embodiment of the invention.

In Block 810, a sound model is selected. In one embodiment, the sound model is stored within a profile as shown in the Block 640. Further, the sound model is shown as being created within the Block 630 in one embodiment. In one embodiment, the sound model represents a voice of a celebrity.

In Block 820, text is displayed. In one embodiment, the text is displayed to prompt the user to vocalize the text that is displayed. In one embodiment, the particular text is selected based on the specific sound model selected in the Block 810. For example, if the sound model selected is a representation of the celebrity Arnold Schwarzenegger, then the text displayed may include portions associated with Arnold Schwarzenegger such as “I'll be back!”

In Block 830, an audio signal is detected. In one embodiment, the audio signal is a representation of a user's voice. In another embodiment, the audio signal is a representation of a sound. The length of the audio signal is detected over a period of time. In one embodiment, the period of time is over the course of several seconds. In another embodiment, the period of time is over the course of several minutes. In one embodiment, the audio signal is divided into separate frames. In one instance, each frame contains between 8 and 20 milliseconds of the audio signal. In one embodiment, a series of frames comprise a contiguous portion of the audio signal.

In one embodiment, the audio signal is an audio representation of the text displayed in the Block 820. Further, the length of the audio signal corresponds to the length of the text displayed in the Block 820.

In Block 840, the audio signal as detected in the Block 830 is transformed according to at least one parameter as described within the sound model as detected in the Block 810.

In Block 850, the transformed audio signal is compared against the audio signal detected in the Block 830 and the sound model detected in the Block 810 for errors.

In another embodiment, the transformed audio signal is compared against an actual audio signal associated with the sound model detected in the Block 810 and the text displayed in the Block 820. For example, the sound model selected in the Block 810 corresponds with Arnold Schwarzenegger. In this example, there is an actual voice audio signal from Arnold Schwarzenegger depicting the text displayed in the Block 820. In this instance, this actual voice audios signal is compared with the transformed audio signal.

In Block 860, if there is a sufficient sample collected from the detected audio signal, then a score is displayed in Block 870. In one embodiment, the score represents the accuracy of the comparison between the transformed audio signal in the Block 850. For example, if the transformed audio signal accurately represents the actual voice audio signal, then the score has a higher numeric value. On the other hand, if the transformed audio signal fails to accurately represent the actual voice audio signal, then the score has a lower numeric value.

If the detected audio signal lacks a sufficient sample size in the Block 860, then additional text is displayed in the Block 820 followed by an additional audio signal detected in the Block 830.

Returning back to FIG. 3, the device driver 310 may include pre-loaded sound models and profiles in one embodiment. Further, the device driver 310 may also include the sound processing module 410, the voice transformation module 420, the voice comparison module 445, and/or the voice profile module 460.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed:

1. A method comprising:
detecting an original audio signal;
detecting a sound model wherein the sound model includes a sound parameter;
transforming the original audio signal based on the parameter whereby forming a transformed audio signal; and
comparing the transformed audio signal with the original audio signal.

2. The method according to claim 1 further comprising storing the sound model within a profile.

3. The method according to claim 1 further comprising playing back the transformed audio signal.

4. The method according to claim 1 wherein the sound model represents characteristics of a voice.

5. The method according to claim 4 wherein the voice belongs to a public figure.

6. The method according to claim 1 wherein the sound parameter is one of a pitch, speed, formant, and inflection.

7. The method according to claim 1 wherein the comparing further comprises detecting an error with the transformed audio signal.

8. The method according to claim 1 wherein the audio signal has a duration of a period of time.

9. The method according to claim 1 wherein the audio signal comprises a plurality of frames.

10. A method comprising:
selecting a sound model;
displaying text associated with the sound model;
detecting an original audio signal in response to the text; and
transforming the original audio signal based on the sound model and forming a transformed audio signal.

11. The method according to claim 10 further comprising comparing the transformed audio signal with a sound clip wherein the sound clip reflects the text.

12. The method according to claim 11 further comprising scoring the transformed audio signal based on comparing the transformed audio signal with the sound clip.

13. The method according to claim 11 wherein the sound clip originates from a voice of a public figure and wherein the sound model is based on the public figure.

14. The method according to claim 10 wherein the sound model includes a sound parameter.

15. The method according to claim 14 wherein the sound parameter is one of a pitch, speed, formant, and inflection.

16. A method comprising:
detecting an audio signal from a source;
analyzing the audio signal for a short term parameter;
analyzing the audio signal for a long term parameter;
forming a sound model based on the short term parameter and the long term parameter; and
storing the sound model.

17. The method according to claim 16 wherein the source represents a voice of a person.

18. The method according to claim 16 wherein the source is pre-recorded media.

19. The method according to claim 16 wherein the short term parameter includes one of pitch, formant, inflection, and speed.

20. The method according to claim 16 wherein the long term parameter includes one of rhythm and spectral envelope.

21. A system, comprising:
a sound processing module configured for processing incoming audio signals;
an audio profile module configured for storing a parameter associated with a sound model; and
a voice transformation module configures for transforming the incoming audio signals according to the sound model and forming transformed audio signals.

22. The system according to claim 21 further comprising a storage module configured for storing the sound model.

23. The system according to claim 21 further comprising a voice comparison module configured to compare the transformed audio signals with the incoming audio signals based on the sound model.

24. The system according to claim 21 further comprising a voice comparison module configured to compare the transformed audio signals with a source audio signal corresponding with a source of the sound model.

25. A computer-readable medium having computer executable instructions for performing a method comprising:
detecting an original audio signal;
detecting a sound model wherein the sound model includes a sound parameter;
transforming the original audio signal based on the parameter whereby forming a transformed audio signal; and
comparing the transformed audio signal with the original audio signal.
